(19) United States
(12) Patent Application Publication
(10) Pub. No.: US 2022/0349299 A1
(43) Pub. Date: Nov. 3, 2022

(54) ACROLEIN LEAK DETECTION AND ALERT SYSTEM

(71) Applicant: Halliburton Energy Services, Inc., Houston, TX (US)

(72) Inventors: Charles Edward Wilson, III, Midland, TX (US); Johnny Lee Roe, Brownfield, TX (US); Yulia Sergeyevna Mosina, Kingwood, TX (US); Christopher John Holp, Longview, TX (US)

(21) Appl. No.: 17/621,496

(22) PCT Filed: Jul. 25, 2019
(86) PCT No.: PCT/US2019/043363

§ 371 Date: Dec. 21, 2021

(51) Int. Cl. E21B 47/117; E21B 47/06; E21B 47/113; E21B 37/06

(52) U.S. Cl. CPC E21B 47/117; E21B 47/06; E21B 47/113; E21B 37/06

(57) ABSTRACT

These drawings Illustrate certain aspects of some of the embodiments of the present disclosure, and should not be used to limit or define the claims. FIG. 1 is a schematic diagram of an acrolein injection system and acrolein leak detection and alert system that may be used in accordance with certain embodiments of the present disclosure. FIG. 2 is another schematic diagram of an acrolein injection system and acrolein leak detection and alert: system that may be used in accordance with certain embodiments of the present disclosure. FIG. 3 is another schematic diagram of an acrolein injection system and acrolein leak detection and alert system that may be used in accordance with certain embodiments of the present disclosure. FIG. 4 is a diagram illustrating an example of a wellbore drilling assembly that may be used in accordance with certain embodiments of the present disclosure. While embodiments: of this disclosure have been depicted, such embodiments do not imply a limitation on the disclosure, and no such limitation should be inferred. The subject matter disclosed is capable of considerable modification, alteration, and equivalents in form: and function, as will occur to those skilled in the pertinent art and having the benefit of this disclosure. The depicted and described embodiments of this disclosure are examples only, and not exhaustive of the scope of the disclosure.

### BACKGROUND

The present disclosure relates to systems and method for acrolein treatment of equipment at a hydrocarbon producing well site.

Hydrocarbon producing wells may contain many different formation sulfides, water, and other compounds. Hydrogen sulfide (H₂S), produced via biogenic or thermogenic sources, is a very toxic, flammable, and pungent gas that causes problems in various aspects of the oil and gas industry. H₂S is extremely corrosive to metal, which may damage or destroy (via severe pitting) tubing, casings, surface facilities, or other types of well bore equipment. Severe iron sulfide (FeS) scaling may also choke production, either in the production piping, injection lines, filters, perforations, or within the producing formation itself. Thus, it is typically desirable to reduce or eliminate sulfides from subterranean formations, well bores, and associated water treatment facilities, among other reasons, to control corrosion rates and to plan for safe development and production of the hydrocarbons.

The release of H₂S gas can sometimes be controlled by maintaining the pH of the fluid containing H₂S above 10. However, in many cases, it is not practical or possible to maintain this level pH in a fluid for extended periods of time. Sulfide scavengers are often used to react with H₂S and convert it to a more inert form. Acrolein (2-propenal) is known to act on H₂S and FeS through irreversible chemical reaction with the sulfide, producing water soluble, non-toxic, low molecular weight products. Acrolein treatments are effective for sulfide scavenging in terms of cost and performance. However, acrolein is a non-conventional chemical compared with conventional oilfield-treatment chemicals. Acrolein is a strong lachrymator, is acutely toxic by inhalation and/or ingestion, and is highly flammable. Due to potential handling and application hazards associated with acrolein, it is now recognized that systems and methods are needed for the application of acrolein at a well site while minimizing impact on the environment and personnel at the well site.

### BRIEF DESCRIPTION OF THE DRAWINGS

These drawings illustrate certain aspects of some of the embodiments of the present disclosure, and should not be used to limit or define the claims.

FIG. 1 is a schematic diagram of an acrolein injection system and acrolein leak detection and alert system that may be used in accordance with certain embodiments of the present disclosure.

FIG. 2 is another schematic diagram of an acrolein injection system and acrolein leak detection and alert system that may be used in accordance with certain embodiments of the present disclosure.

FIG. 3 is another schematic diagram of an acrolein injection system and acrolein leak detection and alert system that may be used in accordance with certain embodiments of the present disclosure.

FIG. 4 is a diagram illustrating an example of a wellbore drilling assembly that may be used in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such as wires, optical fibers, microwaves, radio waves, and other electromagnetic and/or optical carriers; and/or any combination of the foregoing.

The terms “couple” or “couples” as used herein are intended to mean either an indirect or a direct connection. Thus, if a first device couples to a second device, that connection may be through a direct connection, or through an indirect mechanical, electromagnetic, or electrical connection via other devices and connections. Similarly, the term “communicatively coupled” as used herein is intended to mean either a direct or an indirect communication connection. Such connection may be a wired or wireless connection such as, for example, Ethernet or LAN. Such wired and wireless connections are well known to those of ordinary skill in the art and will therefore not be discussed in detail herein. Thus, if a first device communicatively couples to a second device, that connection may be through a direct connection, or through an indirect communication connection via other devices and connections.

The present disclosure relates generally to systems and methods for acrolein treatment of equipment at a hydrocarbon producing well site. More particularly, the present disclosure relates to an acrolein leak detection and alert system for use when applying acrolein as a sulfide scavenger at a hydrocarbon producing well site.

In order to treat problems associated with bacterial activity and sulfides generation at a well site, acrolein (C₃H₄O) can be used as a sulfide scavenger. Acrolein readily and irreversibly reacts with sulfides to form water-soluble products. The unique dual-solubility of acrolein to both oil and water, and the reactivity of acrolein, makes this an effective agent for treating multiple problems in oilfield systems via application of a single chemical. Since it can be applied as a single treatment (e.g., in a water treatment area of the well site), using acrolein minimizes the number of chemical injection points on location, potential releases to the environment, and possible operations-personnel exposures. However, acrolein is known to be toxic and highly flammable. It is now recognized that systems and methods are needed for the continuous application of acrolein at a well site that minimizes impact on the environment and personnel at the well site.

The present disclosure provides an acrolein leak detection and alert system that may quickly detect leaks or potential leaks of acrolein into the environment and may automatically stop acrolein injections and/or alert associated personnel. The disclosed acrolein leak detection and alert system works in conjunction with an acrolein injection system. The acrolein injection system applies an acrolein treatment to well equipment via a closed system utilizing pressurized tanks of acrolein with nitrogen gas blankets and a specially designed manifold. The acrolein leak detection and alert system includes pressure sensors installed on the liquid line of the manifold. The pressure sensors may be installed at the suction and discharge sides of a meter pump that supplies the acrolein for injection. The pressure sensors are communicatively coupled to a control system. If the differential pressure across the pump, detected via these pressure sensors, is not within a predetermined threshold, then the control system may output a control signal to automatically shut off the meter pump and thereby halt acrolein injections. Simultaneously, or nearly simultaneously, the control system may output a control signal to one or more alert systems at the well location. These alert systems may be visual alert systems or audible alert systems that can inform personnel on location of a potential acrolein leak. The control system may also output one or more communication signals to remote devices (e.g., via text message and/or email) of responsible operating personnel. The control system may be remote from the well location or may communicate signals to another control system that is remote from the well location. This may enable the disclosed systems and methods to remotely collect and monitor pressure data and notify responsible personnel in the event of undesired pressure changes that indicate a potential acrolein leak.

Among the many potential advantages of the present disclosure, the methods and systems of the present disclosure may, among other things, provide a means of reducing or minimizing the risk of damage and/or other risks associated with the continuous application of acrolein as a sulfide scavenger at a well location. Such methods and systems may be able to monitor and auto-control an acrolein injection pump remotely so that steps are automatically taken to alert personnel and mitigate the effects of an acrolein spill or leak at the well location.

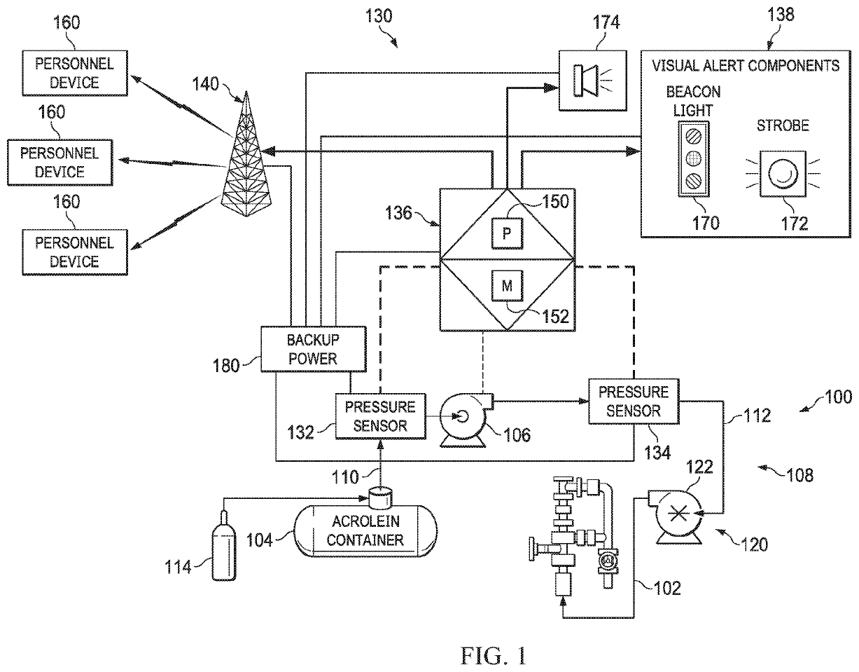

Turning now to the drawings, FIG. 1 illustrates an example system 100 for applying an acrolein treatment to fluid on location of a hydrocarbon producing well, in accordance with the present disclosure. The system 100 may be used to inject acrolein into a flowline 102 at the well location containing a fluid to be treated. In an embodiment, the fluid to be treated via the acrolein may include water used in a water treatment process at the surface of the well location. In an embodiment, the fluid to be treated via the acrolein may include a water, brine, or oil-based treatment fluid that will be pumped into a wellbore at the well location. The system 100 includes an injection point 120 at which acrolein is injected into the flowline 102. In an embodiment, the injection point 120 may include a triplex pump 122 that injects acrolein from the manifold 108 into the flowline 102, although other methods of injection may be possible as well.

The acrolein application system 100 may include one or more acrolein tanks 104, an acrolein meter pump 106, and a manifold 108 through which the acrolein is moved from the tank(s) 104 to the pump 106 and from the pump 106 to the flowline 102. The manifold 108 may include a suction line 110 and a discharge line 112 for the pump 106. The suction line 110 extends from the acrolein tank to the metering pump 106, and the discharge line 112 extends from the metering pump 106 to the injection point 120. As illustrated, the discharge line 112 may be fluidly connected to the flowline 102 communicating the fluid to be treated by the acrolein injection. Specifically, the discharge line 112 may intersect the flowline 102 at the injection point 120. In another embodiment, the pump 106 may inject the acrolein directly into the flowline 102 such that the discharge line 112 is continuous with the flowline 102 carrying the fluid to be treated.

The acrolein tank(s) 104 may be pressurized tanks with nitrogen gas blankets. As such, the acrolein application system 100 may include one or more nitrogen tanks 114 (and any associated pumps) for supplying the nitrogen at a desired pressure to the acrolein tanks 104. Together, the tanks 104, pump 106, and manifold 108 provide a closed system for injecting acrolein into the flowline 102 for sulfide scavenging purposes.

The system 100 may be located on location of a hydrocarbon producing well. In an embodiment, the acrolein injection system 100 is entirely located within a fenced enclosure at the well location. The suction line 110 may be approximately 20 feet to 100 feet in length. The discharge line 112 may similarly be approximately 20 feet to 100 feet in length. The suction and discharge lines 110 and 112, respectively, may both include continuous, stainless steel housings for communicating acrolein from the tanks 104 to the pump 106 and from the pump 106 to the flowline 102. This construction is desirable because acrolein does not react with stainless steel.

The acrolein injection system 100 may provide continuous acrolein injections or batch acrolein injections to the flowline 102. For continuous acrolein injections, the system 100 is installed on location at the well, acrolein injection operations are begun by trained personnel, and the system 100 is then left unattended during continuous injection of acrolein into the flowline 102 for several days. Such continuous injection may be used to provide continuous sulfide scavenging within surface-level cleaning or water treatment facilities at the well location. The acrolein is injected in this manner so that it can continuously react with water cycling through flowlines of the facility to scavenge sulfides and thereby prevent damage to water treatment equipment throughout well operations. The acrolein may be injected continuously to control bacteria levels in the water treatment equipment as well. Continuous acrolein injections may be applied upon determination that sulfides and/or bacteria are being continuously fed into the system. For example, if a formation is soured and the well produces brine that requires sulfide control, continuous acrolein injections at the surface treatment equipment may be desired since it is not feasible to treat the entire formation. For batch acrolein injections, the system 100 is installed on location and an acrolein injection is applied to the flowline 102 via trained personnel operating the pump 106, after which the pump 106 is stopped and the system 100 removed from location. Batch acrolein treatments may be applied when an acute issue with sulfides and/or bacteria is detected within the well system and the issue does not persist after an initial acrolein treatment.

Tho disclosed systems and methods provide enhanced leak detection and alerting of operating personnel in the event of an acrolein leak or potential leak from the system 100. This leak detection and alerting may be particularly useful in instances where the system 100 is being used to provide continuous acrolein injections on location, since the specially trained personnel who set up the acrolein injection system may not be on location for the duration of the continuous application of acrolein alter the initial installation.

An acrolein leak detection and alert system 130 may he built into the acrolein injection system 100. The acrolein leak detection and alert system 130 generally includes a first pressure sensor 132, a second pressure sensor 134, a controller 136, one or more on-location visual alert components 138, and a communication interface 140. The first pressure sensor 132 may be located directly on the suction line 110 upstream of the pump 106, while the second pressure sensor 134 may be located directly on the discharge line 112 downstream of the pump 106. The controller 136 is communicatively connected to the pressure sensors 132 and 134 via a wired or wireless connection. The controller 136 is also communicatively coupled to the pump 106, the visual alert component(s) 138, and the communication interface 140. The acrolein leak detection and alert system 130 includes redundant safety devices built into the acrolein injection system 100 to prevent chemical exposures or misapplications of acrolein.

It is desirable for the pressure sensors 132 and 134 to both be constructed from materials that are compatible with acrolein. For example, the pressure sensors 132 and 134 may be stainless steel pressure gauges disposed on the stainless steel suction line 110 and discharge line 112. The sensors 132 and 134 may be incorporated directly on the suction and discharge lines 110 and 112, respectively, such that there are no fluid line connections at the locations of either sensor. This allows the manifold 108 to provide pressure sensing capabilities via the sensors 132 and 134 without having additional line connections through which acrolein could potentially leak.

The controller 136 includes an information handling system having at least one processing component 150 and at least one memory component 152. The memory component 152 may store instructions that are executed on the processing component 150. For instance, the memory component 152 may store instructions that, upon execution by the processing component 150, cause the controller 136 to receive various sensor signals from the well location, process the sensor signals, and output multiple control signals upon detection of a potential acrolein leak at the well location based on the sensor signals.

The controller 136 is communicatively coupled to the pressure sensors 132 and 114 and configured to receive pressure measurements from the pressure sensors 132 and 134 at regular intervals. In an embodiment, the pressure sensors 132 and 134 may continuously or nearly continuously take pressure readings of the fluid in the suction and discharge lines 110 and 112, respectively. In an embodiment, the pressure sensors 132 and 134 may take pressure readings at specific intervals such as every tenth of a second, every half second, every second, every 5 seconds, every 10 seconds, every 30 seconds, every minute, or some other regular interval. The pressure sensors 132 and 134 may communicate each pressure measurement to the controller 136 for processing. In an embodiment, the controller 136 may be located at the well location and the pressure sensors 132 and 134 may be communicatively coupled to the controller 136 via a direct wired connection. In another embodiment, the controller 136 may be located remote from the well location and the pressure sensors 132 and 134 may be communicatively coupled to the controller 136 via a wireless connection. In such instances, the pressure sensors 132 and 134 may include or be coupled to one or more transmitters that transmit wireless signals of data indicative of the collected pressure measurements to the controller 136.

The controller 136, upon receiving a pressure measurement from the first pressure sensor 132 and a pressure measurement from the second pressure sensor 134, may determine whether a potential acrolein leak is present within the acrolein injection system based on the two pressure measurements. The controller 136 may sync up the received pressure signals from the first and second pressure sensors 132 and 134 with respect to time such that readings from the two sensors that were taken at the same time are associated with each other. The controller 136 calculates a differential pressure between the two pressure measurements at a specific time and compares the differential pressure to upper and lower predetermined threshold values. The controller 136 determines that a leak is present within the acrolein injection system 100 if the pressure differential is outside of the range of predetermined threshold values (e.g., due to a pressure spike or drop measured from one of the sensors 132 and 134).

The lower and upper threshold values of the pressure differential used to determine whether a potential leak is present may be any desired values that are outside of a normal or expected operating differential pressure for the acrolein injection system 100. As an example, the expected operating differential pressure may be from about 20 psi up to about 30 psi. In this case, the lower pressure differential threshold value may be set to 20 psi and the upper differential pressure threshold value may be set to 30 psi. For some embodiments, the expected operating differential pressure may be from about 25 psi up to about 35 psi. In this case, the lower pressure differential threshold value may be set to 25 psi and the upper differential pressure threshold value may be set to 35 psi. The differential pressure threshold values may be determined at the start off continuous operation of the acrolein injection system 100. That is, before operating the acrolein leak detection and alert system 130, the acrolein injection system 100 may be run for a certain length of time with pressure measurements taken via the sensors 132 and 134 at regular intervals to determine the normal operating range for the system. In some embodiments, the total amount of time in which the acrolein injection system 100 is run for these initial measurements may be within a range of from about 1 hour to about 24 hours, alternatively from about 2 hours to about 18 hours, or alternatively from about 4 hours to about 12 hours. The initial pressure measurements may be taken at regular intervals from about every 1 minute to every 30 minutes, alternatively from about every 5 minutes to every 20 minutes, or alternatively every 10 minutes. Even using the same equipment, the normal operating range for the pressure differential may vary between different well sites due to minor differences in the equipment setup.

Upon determining a leak is present based on the pressure measurements, the controller outputs control signals to the metering pump 106, the visual alert component(s) 138, and the communication interface 140 to execute a three-part mitigation and alert operation. The three-part mitigation and alert operation includes halting acrolein injection operations to minimize the effect of an acrolein leak, alerting on-location personnel to the existence of a leak so that the personnel can take appropriate measures to minimize exposure to the leak (such as evacuating the area or seeking shelter indoors), and alerting remote personnel to the existence or potential existence of the leak. These three parts of the mitigation and alert operation will now be described in detail.

Upon determining a leak is present in the acrolein injection system 100, the controller 136 may output a control signal to the metering pump 106 to automatically shut off the pump 106. This will prevent the pump 106 from continuing to pull acrolein from the tank 104 while a leak is present downstream of the tank 104. Automatically shutting off the pump 106 will help to reduce an amount of acrolein released into the environment through the leak, thereby mitigating any damaging effects of the leak.

In addition, upon determining a potential leak is present, the controller 136 outputs a signal to control one or more visual alert components 138 disposed at the well location. These visual alert components 138 may include one or more different types of lights that will notify personnel on location of the presence of a leak in the acrolein injection system 100.

The visual alert components 138 may include one or more beacon lights 170 that switch between different colors based on the signal from the controller 136. For example, the beacon light 170 may shine a green light initially and during regular operation of the acrolein injection system 100. Upon determining a potential leak is present, the controller 136 may send a control signal to die beacon light 170 that switches the beacon light from the green light to shining a red light. One or more of these beacon lights 170 may be utilized in indoor or outdoor locations at the well location. Beacon lights 170 may be particularly useful in outdoor areas of the well location as they indicate to operating personnel who are outside of the fenced enclosure in which the acrolein injection system 100 is located to not approach the area. In some embodiments, the red light of the beacon 170 may be a flashing red light, which may attract more attention of operating personnel on location.

The visual alert components 138 may include, in addition to or in lieu of beacon lights, one or more strobe lights 172 that flash repeatedly upon activation based on the signal from the controller 136. The strobe light 172 may be completely off initially and during regular operation of the acrolein injection system 100. Upon determining a potential leak is present, the controller 136 may send a control signal to the strobe light 172 that activates the strobe light so that it flashes bright light continuously. One or more strobe lights 172 may be utilized in indoor or outdoor locations at the well location. Strobe lights 172 may be particularly useful in indoor areas such as the pumphouse at the well location as strobe lights would attract attention of workers who may otherwise be too preoccupied with what they are looking at to notice a light simply changing color.

The activation of one or more visual alert components 138 via the controller 136 may be accompanied by a similar activation of one or more audible alert components 174 on location. These audible components 174 may include, for example, one or more sirens, alarms, voice recordings of instructions to be followed by personnel on location, and others. The visual alert components 138 and/or audible alert components 174 may provide a local warning to operating personnel who are currently at the well location during the detection of a leak in the acrolein injection system 100.

In addition to the local warning, the leak detection and alert system 130 also provides a remote electronic warning to personnel, including those who are not currently at the well location during the detection of a leak in the acrolein injection system 100. Upon determining a potential leak is present, the controller 136 outputs a signal to the communication interface 140 causing the communication interface 140 to send wireless communications to devices 160 of one or more personnel. The devices 160 may include any desired personal device such as, for example, a cellular phone, tablet, or personal computer. The communication interface 140 may send an automated notification via text message, phone call with a recording, electronic mail, or any combination thereof, to the personnel devices 160. The automated notification may include a current status of the potential leak at the well location, instructions to the personnel in light of the current status, or both.

In an embodiment, the communication interface 140 may automatically send the same notification to all personnel devices 160. In another embodiment, the communication interface 140 may automatically send at least one notification to the devices 160 of a first subset of personnel associated with the well location and at least one other notification to the devices 160 of a second subset of personnel associated with the well location. For example, the communication interface 140 may send a first automated notification to the devices 160 belonging to a group of personnel who work at the well location but not specifically with the acrolein injection system 100, and simultaneously a second automated notification to the devices 160 belonging to a group of personnel who are responsible for operation and/or maintenance of the acrolein injection system 100. The first automated notification may include instructions to either stay away from the well location or take specific precautions upon approaching the well location, for example. At a later time, when a potential leak has been fixed, prevented, mitigated, or discovered to be a false alarm, a new notification may be sent to the personnel devices 160 in the first group updating the status and/or notifying the personnel that it is safe to approach the well location. The second automated notification sent to the second group of personnel may immediately notify the remote personnel of the detected potential leak so that the personnel know to come to the well location and perform any necessary maintenance, inspections, or operations to fix the leak or remove the acrolein injection system from the well location.

In an embodiment, the controller 136, the communication interface 140, or both may be located remote from the well location. The metering pump 106 and visual/audible alert components 138/174 may each be communicatively coupled to the controller 136 via a wireless communication interface. In this embodiment, the controller 136 is able to provide remote monitoring and controlling of the acrolein injection system 100 as well as transmission of data about the acrolein injection system 100 to personnel during acrolein continuous or batch injection operations.

As illustrated, components of the acrolein leak detection and alert system 130 may be coupled to one or more backup power sources 180, such as a backup battery at the well location. For example, the pressure sensors 132/134, controller 136, alert components 138/174, and communication interface 140 may each be coupled to the backup power source 180. In embodiments where the controller 136 and/or communication interface 140 are located remote from the well location, the backup power source 180 may only be used to provide backup power to the pressure sensors 132/134 and alert components 138/174. Upon switching to the auxiliary power source 180 in the event of loss of power at the well location, the backup power source 180 may output a signal to the controller 136. The controller 136, upon receiving a signal indicative of the switch to auxiliary power, may output a control signal causing the communication interface 140 to send notifications to appropriate personnel devices 160 of the switch to backup power.

While the leak detection and alert system 130 may not reduce the probability of a leak in the acrolein injection system 100, the system 130 may significantly reduce negative consequences in the event of an acrolein leak or release.

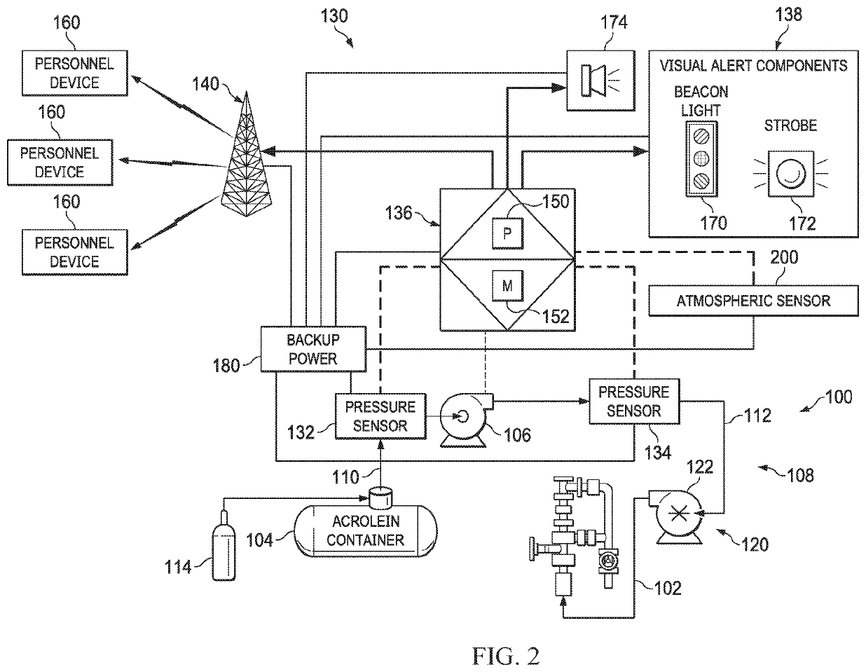

It may be desirable to utilize additional sensors along with the pressure sensors 132 and 134 in the disclosed acrolein leak detection and alert system 130. FIG. 2 illustrates another embodiment of the acrolein leak detection and alert system 130 working in conjunction with the acrolein injection system 100. In FIG. 2, the acrolein leak detection and alert system 130 includes at least one atmospheric sensor (or aldehyde sensor) 200 in addition to the pressure sensors 132 and 134. The atmospheric or aldehyde sensor 200 is located outside of the closed acrolein leak injection system 100. Specifically, the atmospheric or aldehyde sensor 200 may be located at the well location nearby but outside of the metering pump 106 and manifold 108. The atmospheric or aldehyde sensor 200 may include any type of sensor capable of detecting a release of acrolein vapor into the environment. For example, in an embodiment the atmospheric or aldehyde sensor 200 may include an infrared sensor for monitoring acrolein vapor release from the closed acrolein injection system 100. The atmospheric or aldehyde sensor 200 may be exposed to the ambient air surrounding the acrolein injection system 100 and capable of detecting the presence of acrolein in the ambient air in amounts above a predetermined threshold. The atmospheric or aldehyde sensor 200 is configured to detect aldehydes (including acrolein) in the atmosphere. An example of an aldehyde sensor 200 that may be used is MP series gas monitoring system Model 4-20 IQ with solid state sensors, available from International Sensor Technology. These sensors have a full scale range of 50 ppm for acrolein detection.

As illustrated, the controller 136 may be communicatively coupled to the atmospheric or aldehyde sensor 200 in addition to the pressure sensors 132 and 134 and configured to receive both atmospheric/aldehyde sensor measurements as well as pressure measurements at regular intervals. In an embodiment, the atmospheric or aldehyde sensor 200 may continuously or nearly continuously take readings of the ambient air at the well location. In an embodiment, the atmospheric or aldehyde sensor 200 may take readings at specific intervals such as every tenth of a second, every half second, every second, every 5 seconds, every 10 seconds, every 30 seconds, every minute, or some other regular interval. The atmospheric or aldehyde sensor 200 may communicate each reading to the controller 136 for processing. In an embodiment, the controller 136 may be located at the well location and the atmospheric or aldehyde sensor 200 may be communicatively coupled to the controller 136 via a direct wired connection. In another embodiment, the controller 136 may be located remote from the well location and the atmospheric or aldehyde sensor 200 may be communicatively coupled to the controller 136 via a wireless connection. In such instances, the atmospheric/aldehyde sensor 200 may include or be coupled to a transmitter that transmits wireless signals of sensor data to the controller 136.

The controller 136, upon receiving the pressure measurements from the pressure sensors 132 and 134 and the measurements from the atmospheric/aldehyde sensor 200, may determine whether an acrolein leak or potential leak is present within the acrolein injection system based on the sensor measurements. For example, in addition to determining the pressure differential between the two pressure measurements at a specific time and comparing the differential pressure to a predetermined threshold, the controller 136 may also compare the amount of acrolein vapor (if any) detected via the atmospheric/aldehyde sensor 200 to a predetermined threshold. This predetermined threshold may be a concentration of acrolein vapor above zero parts per million, above 50 parts per million, or above 100 parts per million. In the event the controller determines a likely or possible acrolein leak based on the pressure measurements, the controller 136 may utilize the measurement from the atmospheric/aldehyde sensor 200 to confirm the presence of an acrolein leak. In the event the controller does not determine a possible acrolein leak based on the pressure measurements, the controller 136 may utilize the measurement from the atmospheric/aldehyde sensor 200 to either 1) confirm the absence of an acrolein leak if the sensor 200 detects zero ppb of acrolein vapor or; 2) override this determination if the sensor 200 detects the presence of acrolein vapor in the atmosphere.

Upon determining a leak is present in the acrolein injection system 100 based on the measurements from sensors 132, 134, and 200, the controller 136 may operate as discussed at length above with reference to FIG. 1. Specifically, the controller 136 may output a control signal to the metering pump 106 to automatically shut off the pump 106, output a signal to control one or more alert components 138/174 disposed at the well location, and provide a remote electronic warning to personnel via the communication interface 140. The acrolein leak detection and alert system 130 of FIG. 2 may similarly be equipped with a backup power source 180, the operation of which is discussed at length above with reference to FIG. 1.

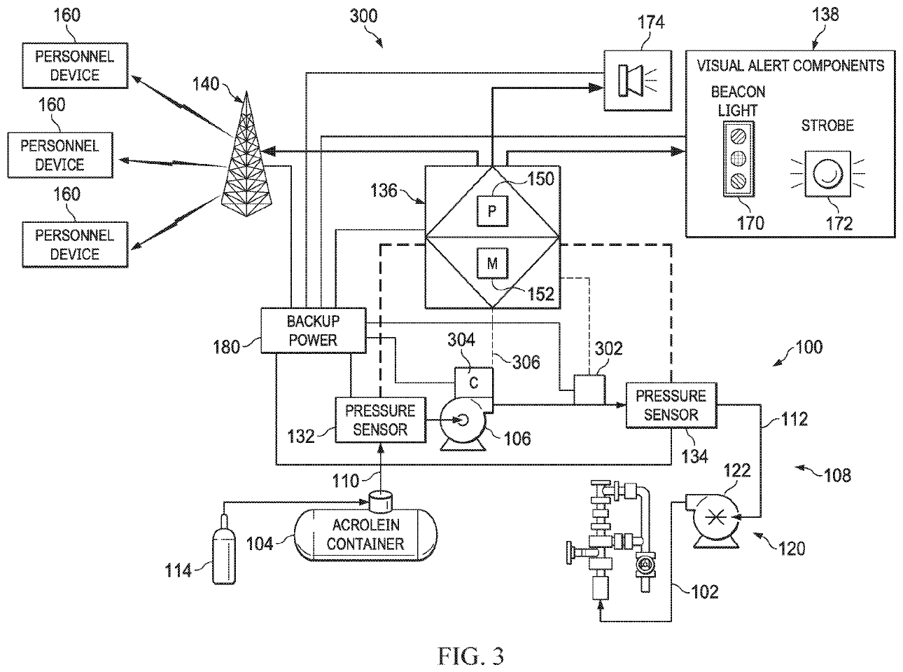

It may be desirable to monitor and control a flowrate of acrolein being moved through the acrolein injection system 100. The equipment components used to provide this control/monitoring of the acrolein flowrate may also be used in an acrolein leak detection and alert system. FIG. 3 shows the acrolein injection system 100 operating in conjunction with one such acrolein leak detection and alert system 300. Similar to the systems 130 of FIGS. 1 and 2, the acrolein leak detection and alert system 300 of FIG. 3 includes the controller 136, alert components 138/174, and communication interface 140; the acrolein leak detection and alert system 300 may also include a backup power source 180, as described above. In addition, the acrolein leak detection and alert system 300 of FIG. 3 includes at least one flowrate sensor 302 for detecting a flowrate of acrolein being pumped through the manifold 108. The flowrate sensor 302 may be located directly on the discharge line 112 downstream of the pump 106. The controller 136 is communicatively connected to the flowrate sensor 302 (and any other desired sensors), the alert component(s) 138/174, and the communication interface 140.

In an embodiment, the acrolein leak detection and alert system 300 may include only the flowrate sensor 302 and no other types of sensors used to detect a potential leak. In other embodiments, the acrolein leak detection and alert system 300 may also include pressure sensors 132 and 134 as described above with reference to FIGS. 1 and 2, an atmospheric/aldehyde sensor 200 as described above with reference to FIG. 2, or both. For example, the illustrated acrolein leak detection and alert system 300 includes the pressure sensors 132 and 134 along with the flowrate sensor 302.

It is desirable for the flowrate sensor 302 to be constructed from materials that are compatible with acrolein. For example, the flowrate sensor 302 may be a stainless steel flowrate sensor disposed on the stainless steel discharge line 112. The sensor 302 may be incorporated directly on the discharge line 112 such that there are no fluid line connections at the location of the sensor 302. This allows the manifold 108 to provide flowrate sensing capabilities via the flowrate sensor 302 without having additional line connections through which acrolein could potentially leak.

The flowrate sensor 302 may include any type of sensor capable of detecting a flowrate of acrolein being pumped through the manifold toward the injection point 120. The flowrate sensor 302 may detect a flowrate of the acrolein being metered via the pump 106. When the acrolein injection system 100 is working as desired, the flowrate measured by the flowrate sensor 302 is proportional to the operating speed of the metering pump 106.

In the acrolein leak injection system 100 of FIG. 3, the metering pump 106 may be a variable speed pump which is able to pump the acrolein through the injection system at different flow rates depending on the sulfide scavenging needs within the flowline 102 and associated equipment at the well location. In this embodiment, the metering pump 106 may be equipped with a variable speed motor or drive, and/or a dedicated pump control system 304 for adjusting the flowrate of acrolein output from the pump 106. The controller 136 may be communicatively coupled to the variable speed motor or drive, and/or control system 304 for the pump 106 (e.g., via wired or wireless connection 306) to control the flowrate of the pump 106.

As illustrated, the controller 136 is also communicatively coupled to the flowrate sensor 302 to receive flowrate measurements. In an embodiment, the flowrate sensor 302 may continuously or nearly continuously take readings of the acrolein flowrate through the discharge line 112. In an embodiment, the flowrate sensor 302 may take readings at specific intervals such as every tenth of a second, every half second, every second, every 5 seconds, every 10 seconds, every 30 seconds, every minute, or some other regular interval. The flowrate sensor 302 may communicate each reading to the controller 136 for processing. In an embodiment, the controller 136 may be located at the well location and the flowrate sensor 302 may be communicatively coupled to the controller 136 via a direct wired connection. In another embodiment, the controller 136 may be located remote from the well location and the flowrate sensor 302 may be communicatively coupled to the controller 136 via a wireless connection. In such instances, the flowrate sensor 302 may include or be coupled to a transmitter that transmits wireless signals of sensor data to the controller 136. As mentioned above, the controller 136 may also be similarly communicatively coupled to pressure sensors 132 and 134.

In the embodiment of FIG. 3, the controller 136 may receive the flowrate measurements from the flowrate sensor 302 and monitor the flowrate of acrolein through the acrolein injection system 100 based on the received sensor measurements. The controller 136 may output control signals to the metering pump 106 in response to the detected flowrate measurements. Specifically, the controller 136 may output control signals to the variable speed motor, drive, or control system 304 to adjust the operating speed of the pump 106 to ensure that the flowrate of acrolein exiting the pump 106 is at a desired value or within a desired range.

The controller 136, upon receiving the flowrate measurements from the flowrate sensor 302, may also use the measurements to determine whether a potential acrolein leak is present within the acrolein injection system. For example, the controller 136 may compare the detected flowrate of acrolein through the discharge line 112 to the flowrates measured over a length of time previously when the pump 106 was operated at the same speed. If the detected flowrate is still within the expected range, then the controller 136 may determine that no potential leak is present. If the detected flowrate is lower than expected or previously measured when the pump 106 is operating at the same speed, then the controller 136 may determine that a potential leak is present in the acrolein injection system 100.

As discussed above, the acrolein leak injection system 300 of FIG. 3 may also include the pressure sensors 132 and 134. Measurements taken from these pressure sensors 132 and 134 may be used in addition to the flowrate measurements to determine whether an acrolein leak is present or potentially present within the acrolein injection system 100. For example, the controller 136 may determine the pressure differential between the two pressure measurements at a specific time and compare the differential pressure to a predetermined threshold, as discussed at length above to determine the potential presence of a leak. In the event the controller determines a likely or possible acrolein leak based on the flowrate measurements, the controller 136 may utilize the measurements from the pressure sensors 132 and 134 to confirm the presence of an acrolein leak. In embodiments where one or more atmospheric/aldehyde sensors are incorporated into the system 300 as well, the controller 136 may similarly utilize the measurement from the atmospheric/aldehyde sensor to confirm the presence of an acrolein leak.

Upon determining a potential leak is present in the acrolein injection system 100 based on the measurements from the flowrate sensor 302 and/or the pressure sensors 132 and 134, the controller 136 may operate as discussed at length above with reference to FIG. 1. Specifically, the controller 136 may output a control signal to the variable speed metering pump 106 to completely shut off the pump 106, output a signal to control one or more alert components 138/174 disposed at the well location, and provide a remote electronic warning to personnel via the communication interface 140.

The acrolein leak detection and alert systems used in the present disclosure may provide an application of acrolein to well equipment. The acrolein used in the present disclosure may have a composition of approximately 96% pure acrolein (C₃H₄O) by weight along with trace amounts of water and acetaldehyde, stabilized with 0.3% hydroquinone. This formulation may be a clear, colorless, or light amber liquid with a molecular weight of approximately 56.06 grams per mole. However, the disclosed embodiments may be applicable for detecting leaks of acrolein having other compositions as well. Regardless of the exact formulation of the acrolein used in the system, the acrolein is injected into a flowline at the well location as a liquid. The acrolein used in the present disclosure may exhibit, among other features, an enhanced ability to scavenge sulfides as compared to sulfide scavengers that are conventionally injected into a flowline at the well location. The acrolein leak detection and alert system of the present disclosure may provide, among other things, fast and efficient mitigation of potential acrolein leaks on location, as well as automatic notifications to personnel both at the well location and at remote locations alerting the personnel to any potential leaks. This may improve sulfide scavenging operations at a well site by providing a system that can reduce, minimize, or prevent exposure of personnel to leaks, so that the use of acrolein as a sulfide scavenger may be more efficient or acceptable at various well locations.

The acrolein injection system 100 may inject acrolein into a treatment fluid within flowline 102 in any amount that effectively eliminates or reduces by the desired amount concentrations of H₂S or sulfide ions that are present or expected to be present in the treatment fluid. In certain embodiments, the acrolein may be included in an amount of from about 0.0002% to about 1.5% by weight into the treatment fluid, alternatively from about 0.001% to about 0.5% by weight into the treatment fluid, or alternatively from about 0.01% to about 0.1% by weight into the treatment fluid. An initial amount of the acrolein may he added to a treatment fluid, and subsequently, additional amounts of acrolein may be added to the same fluid. This technique may be used, among other purposes, to increase and/or maintain a concentration of acrolein that is sufficient to effectively eliminate or reduce by the desired amount concentrations of H₂S or sulfide ions in the fluid throughout the course of a given operation.

The disclosed methods may involve injecting acrolein into the flowline 102 with any fluid at the well location, which may include, but is not limited to, treatment fluids used to treat water or other fluids at a surface level treatment facility, treatment fluids introduced into a subterranean formation, fluids found in a subterranean formation (e.g., formation water hydrocarbon fluids, etc.), and/or any combination thereof. The treatment fluids and formation fluids in the present disclosure generally includes a base liquid which may include any liquid known in the art, such as aqueous liquids, non-aqueous liquids, or any mixture thereof. Where the base liquid includes an aqueous liquid, it may include fresh water, salt water (e.g., water containing one or more salts dissolved therein), brine (e.g., saturated salt water), or seawater. Generally, the water can be from any source, provided that it does not contain compounds that adversely affect other components of the fluid. Where the base liquid includes a non-aqueous liquid, it may include any number of organic liquids. Examples of suitable organic liquids include, but are not limited to, mineral oils, synthetic oils, esters, and the like. In certain embodiments, the treatment fluids and/or formation fluids in the present disclosure may include emulsions (including invert emulsions), suspensions, gels, foams, or other mixtures of liquids with solids and/or gases.

The fluids into which the acrolein is injected in the present disclosure optionally may include any number of additional additives, including, but not limited to, salts, surfactants, acids, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, dispersants, flocculants, additional H₂S scavengers, CO₂ scavengers, oxygen scavengers, lubricants, viscosifiers, breakers, weighting agents, relative permeability modifiers, resins, particulate materials (e.g., proppant particulates), wetting agents, coating enhancement agents, and the like. A person skilled in the art, with the benefit of this disclosure, will recognize the types of additives that may be included in the fluids of the present disclosure for a particular application.

The methods of the present disclosure may be used during or in conjunction with any subterranean or surface level operations wherein a fluid is used or treated. In certain embodiments, the methods of the present disclosure may be used in the course of drilling operations. In these embodiments, the methods and systems for acrolein injections of the present disclosure may be used to reduce or eliminate concentrations of H₂S from a drilling fluid used in drilling a well or borehole, for example, in a hydrocarbon-bearing subterranean formation where H₂S is often encountered. Other suitable operations may include, but are not limited to, preflush treatments, afterflush treatments, hydraulic fracturing treatments, sand control treatments (e.g., gravel packing), acidizing treatments (e.g., matrix acidizing or fracture acidizing), “frac-pack” treatments, well bore clean-out treatments, and other operations where a treatment fluid may be useful. Such treatment fluids may include, but are not limited to, drilling, fluids, preflush fluids, afterflush fluids, fracturing fluids, acidizing fluids, gravel packing fluids, packer fluids, spacer fluids, and the like. In certain embodiments, the methods and acrolein injection systems of the present disclosure may be used to reduce or eliminate concentrations of H₂S released to the atmosphere by adding the treatment fluids to pits and settling ponds on location proximate the well.

The acrolein may be provided in an additive in a liquid form (e.g., in solution with a solvent). The acrolein may be added to a fluid by any means known in the art. The acrolein may be added to the fluid, for example, in the mud pit before the fluid has circulated or before the fluid contains any detectable amount of sulfide or H₂S, as a prophylactic measure against any H₂S the fluid may encounter downhole. In certain embodiments, the acrolein may be added after the fluid has been circulating downhole and has already encountered sulfide or H₂S and contains the same. The acrolein may be injected directly into a production flowline below the wellhead (e.g., via an injection quill), where it can be used to remove sulfide or H₂S from oil-water mixed production fluids. In certain embodiments, the amount of acrolein added to the fluid may be controlled and/or varied during the course of an operation based on, among other things, the amount of sulfide or H₂S detected in fluids exiting the well bore. In these embodiments, any system or technique capable of monitoring or detecting sulfide or H₂S content in fluids exiting the well bore may be used. Moreover, the acrolein may be added to a fluid in multiple portions that are added to the fluid at separate intervals over a period of time. For example, a first amount of acrolein may be added to a fluid at one point in time in the course of a particular operation. At a subsequent point during that operation, an elevated amount of sulfide or H₂S may be detected exiting the well bore, at which point a second amount of acrolein may be added to the fluid based at least in part on the amount of sulfide or H₂S detected.

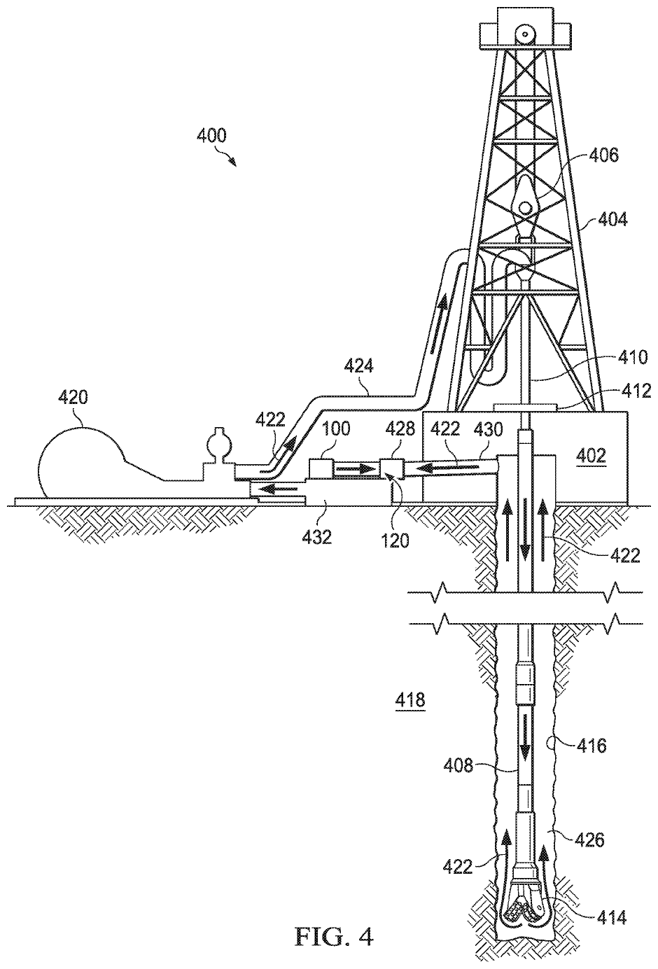

The examples of systems and methods disclosed herein may directly or indirectly affect one or more components or pieces of equipment associated with the preparation, delivery, recapture, recycling, reuse, and/or disposal of the acrolein treated fluids. For example, and with reference to FIG. 4, the fluids and additives (i.e., acrolein) may directly or indirectly affect one or more components or pieces of equipment associated with an exemplary wellbore drilling assembly 400, according to one or more embodiments. It should be noted that while FIG. 4 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 400 may include a drilling platform 402 that supports a derrick 404 having a traveling block 406 for raising and lowering a drill string 408. The drill string 408 may include, but is not limited to, drill pipe and coiled tubing, as generally known to those skilled in the art. A kelly 410 supports the drill string 408 as it is lowered through a rotary table 412. A drill bit 414 is attached to the distal end of the drill string 408 and is driven either by a downhole motor and/or via rotation of the drill string 408 from the well surface. As the bit 414 rotates, it creates a borehole 416 that penetrates various subterranean formations 418.

A pump 420 (e.g., a mud pump) circulates drilling fluid 422 through a feed pipe 424 and to the kelly 410, which conveys the drilling fluid 422 downhole through the interior of the drill string 406 and through one or more orifices in the drill bit 414. The drilling fluid 422 is then circulated back to the surface via an annulus 426 defined between the drill string 408 and the walls of the borehole 416. At the surface, the recirculated or spent drilling fluid 422 exits the annulus 426 and may be conveyed to one or more fluid processing unit(s) 428 via an interconnecting flow line 430. After passing through the fluid processing unit(s) 428, a “cleaned” drilling fluid 422 is deposited into a nearby retention pit 432 (i.e., a mud pit). While illustrated as being arranged at the outlet of the wellbore 416 via the annulus 426, those skilled in the art will readily, appreciate that the fluid processing unit(s) 428 may he arranged at any other location in the drilling assembly 400 to facilitate its proper function, without departing from the scope of the disclosure.

The disclosed acrolein injection system 100 may add the acrolein to fluid at an injection point 120 within or communicably coupled to the fluid processing unit(s) 428. In other embodiments, however, the disclosed additives may be added to the drilling fluid 422 at any other location in the drilling assembly 400. For example, the disclosed acrolein injection system may add the acrolein to the drilling fluid 422 at an injection point communicatively coupled to or otherwise in fluid communication with the retention pit 432. In at least one embodiment, there could be more than one retention pit 432, such as multiple retention pits 432 in series. Moreover, the retention pit 432 may be representative of one or more fluid storage facilities and/or units where treated fluid may be stored, reconditioned, and/or regulated until added to the drilling fluid 422.

As mentioned above, the injected acrolein may directly or indirectly affect the components and equipment of the drilling assembly 400. For example, the acrolein may be injected into fluid within the fluid processing unit(s) 428 which may include, but is not limited to, one or more of a shaker (e.g., shale shaker), a centrifuge, a hydrocyclone, a separator (including magnetic and electrical separators), a desilter, desander, a separator, a filter (e.g., diatomaceous earth filters), a heat exchanger, any fluid reclamation equipment. The fluid processing unit(s) 428 may further include one or more sensors, gauges, pumps, compressors, and the like used store, monitor, regulate, and/or recondition fluids.

The acrolein injected via the disclosed systems may directly or indirectly affect the pump 420, which representatively includes any conduits, pipelines, trucks, tubulars, and/or pipes used to fluidically convey the fluids downhole, any pumps, compressors, or motors (e.g., topside or downhole) used to drive the fluids and additives into motion, any valves or related joints used to regulate the pressure or flow rate of the fluids, and any sensors (i.e., pressure, temperature, flow rate, etc.), gauges, and/or combinations thereof, and the like.

The acrolein injected via the disclosed systems may also directly or indirectly affect the various downhole equipment and tools that may come into contact with the treated fluids such as, but not limited to, the drill string 408, any floats, drill collars, mud motors, downhole motors and/or pumps associated with the drill string 408, and any MWD/LWD tools and related telemetry equipment, sensors or distributed sensors associated with the drill string 408. The acrolein may also directly or indirectly affect any downhole heat exchangers, valves and corresponding actuation devices, tool seals, packers and other wellbore isolation devices or components, and the like associated with the wellbore 416. The acrolein may also directly or indirectly alert the drill bit 414, which may include, but is not limited to, roller cone bits, PDC bits, natural diamond bits, any hole openers, reamers, coring bits, etc.

An embodiment of the present disclosure is an acrolein leak detection and alert system including: a metering pump disposed between an acrolein source and an acrolein injection point; a suction line connecting the metering pump to the acrolein source; a discharge line connecting the metering pump to the injection point; a first pressure sensor disposed on the suction line; a second pressure sensor disposed on the discharge line; a controller communicatively coupled to the first pressure sensor and the second pressure sensor; a communication interface communicatively coupled to the controller; and an alert system communicatively coupled to the controller, wherein the controller includes a processing component and a memory component containing a set of instructions that, when executed by the processing component, cause the processing component to: receive pressure measurements from the first and second pressure sensors; determine whether a potential leak is present between the acrolein source and the acrolein injection point based on the pressure measurements; and upon determining a potential leak is present, output a control signal to the metering pump to halt operation of the metering pump, output a control signal to the alert system to initiate a local warning sequence, and output via the communication interface an alert communication to one or more remote personnel devices.

in one or more embodiments described in the preceding paragraph, the metering pump, the suction line, and the discharge line are located at a well location, and the controller is remote from the well location. In one or more embodiments described in the preceding paragraph, the system further includes the acrolein source, wherein the acrolein source is a tank holding acrolein and a nitrogen blanket. In one or more embodiments described in the preceding paragraph, the first and second pressure sensors are constructed from stainless steel. In one or more embodiments described in the preceding paragraph, the metering pump, the suction line, and the discharge line are located at a well location, and the alert system includes at least one light source located at the well location. In one or more embodiments described in the preceding paragraph, the at least one light source includes a first light source that switches from green to red in response to the control signal output from the controller to the alert system, wherein the first light source is located in an outdoor portion of the well location. In one or more embodiments described in the preceding paragraph, the at least one light source includes a second light source that initiates a strobe light sequence in response to the control signal output from the controller to the alert system, wherein the second light source is located inside a pumphouse at the well location. In one or more embodiments described in the preceding paragraph, the system further includes an atmospheric sensor or aldehyde sensor communicatively coupled to the controller, wherein the set of instructions in the memory component, when executed by the processing component, cause the processing component to: receive measurements from the atmospheric or aldehyde sensor; and determine whether the potential leak is present between the acrolein source and the acrolein injection point based on the pressure measurements and the measurements from the atmospheric or aldehyde sensor. In one or more embodiments described in the preceding paragraph, the atmospheric sensor includes an infrared Sensor configured to detect acrolein vapor. In one or more embodiments described in the preceding paragraph, the system further includes a flowrate sensor disposed on the discharge line and communicatively coupled to the controller, wherein the metering pinup is a variable speed pump and the controller outputs control signals to the metering pump to control a flowrate of acrolein. In one or more embodiments described in the preceding paragraph, the system further includes a backup power source coupled to the controller, the first and second pressure sensors, the alert system, and the communication interface.

Another embodiment of the present disclosure is a method for acrolein leak detection and alerting, including: pumping, via a metering pump, acrolein from an acrolein source to an injection point of a flowline at the well location; detecting a first pressure in a suction line disposed between the acrolein source and the metering pump; detecting a second pressure in a discharge line disposed between the metering pump and the injection point: receiving, via a controller, pressure measurements from the first and second pressure sensors; determining, via the controller, whether a potential leak is present between the acrolein source and the acrolein injection point based on the pressure measurements; and upon determining a potential leak is present, outputting a control signal from the controller to the metering pump to halt operation of the metering pump, outputting a control signal from the controller to an alert system to initiate a local warning sequence, and communicating an alert via a communication interface coupled to the controller to one or more remote personnel devices.

In one or more embodiments described in the preceding paragraph, the method further includes transmitting the pressure measurements to the controller, wherein the controller is located remote from the well location. In one or more embodiments described in the preceding paragraph, determining the potential leak is present includes determining whether a differential pressure between the pressure measurements from the first and second pressure sensors is outside a predetermined threshold. In one or more embodiments described in the preceding paragraph, the method further includes initiating the local warning sequence, wherein the local warning sequence includes operating one or more light sources located at the well location. In one or more embodiments described in the preceding paragraph, the method further includes detecting a measurement at the well location via an atmospheric or aldehyde sensor; and determining whether the potential leak is present between the acrolein source and the acrolein injection point based on the pressure measurements and the measurement from the atmospheric or aldehyde sensor. In one or more embodiments described in the preceding paragraph, the method further includes controlling a flowrate of the metering pump pumping the acrolein to the injection point via the controller. In one or more embodiments described in the preceding paragraph, the method further includes: injecting the acrolein into a fluid in the flowline to generate a treated fluid; and performing surface water treatment at the well location via the treated fluid. In one or more embodiments described in the preceding paragraph, the method further includes: providing, power to at least one of the controller, the first and second pressure sensors, the alert system, and the communication interface via a backup power source; and communicating to the one or more remote personnel devices that an acrolein leak detection and alert system is operating on backup power upon providing the power. In one or more embodiments described in the preceding paragraph, the method further includes continuously injecting the acrolein into the flowline.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. While numerous changes may be made by those skilled in the art, such changes are encompassed within the spirit of the subject matter defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. An acrolein leak detection and alert system, comprising:
a metering pump disposed between an acrolein source and an acrolein injection point;
a suction line connecting the metering pump to the acrolein source;
a discharge line connecting the metering pump to the injection point;
a first pressure sensor disposed on the suction line;
a second pressure sensor disposed on the discharge line;
a controller communicatively coupled to the first pressure sensor and the second pressure sensor;
a communication interface communicatively coupled to the controller; and
an alert system communicatively coupled to the controller;
wherein the controller comprises a processing component and a memory component containing a set of instructions that, when executed by the processing component, cause the processing component to;
receive pressure measurements from the first and second pressure sensors;
determine whether a potential leak is present between the acrolein source and the acrolein injection point based on the pressure measurements; and
upon determining a potential leak is present, output a control signal to the metering pump to halt operation of the metering pump, output a control signal to the alert system to initiate a local warning sequence, and output via the communication interface an alert communication to one or more remote personnel devices.

2. The acrolein leak detection and alert system of claim 1, wherein the metering pump, the suction line, and the discharge line are located at a well location, and wherein the controller is remote from the well location.

3. The acrolein leak detection and alert system of claim 1, further comprising the acrolein source, wherein the acrolein source, is a tank holding acrolein and a nitrogen blanket.

4. The acrolein leak detection and alert system of claim 1, wherein the first and second pressure sensors are constructed from stainless steel.

5. The acrolein leak detection and alert system of claim 1, wherein the metering pump, the suction line, and the discharge line are located at a well location, and wherein the alert system comprises at least one light source located at the well location.

6. The acrolein leak detection and alert system of claim 5, wherein the at least one light source composes a first light source that switches from green to red in response to the control signal output from the controller to the alert system, wherein the first light source is located in an outdoor portion of the well location.

7. The acrolein leak detection and alert system of claim 5, wherein the at least one light source comprises a second light source that initiates a strobe light sequence in response to the control signal output from the controller to the alert system, wherein the second light source is located inside a pumphouse at the well location.

8. The acrolein leak detection and alert system of claim 1, further comprising an atmospheric sensor or aldehyde sensor communicatively coupled to the controller, wherein the set of instructions in the memory component, when executed by the processing component, cause the processing component to:
receive measurements from the atmospheric or aldehyde sensor; and
determine whether the potential leak is present between the acrolein source and the acrolein injection point based on the pressure measurements and the measurements from the atmospheric or aldehyde sensor.

9. The acrolein leak detection and alert system of claim 8, wherein the atmospheric sensor comprises an infrared sensor configured to detect acrolein vapor.

10. The acrolein leak detection and alert system of claim 1, further comprising a flowrate sensor disposed on the discharge line and communicatively coupled to the controller, wherein the metering pump is a variable speed pump and the controller outputs control signals to the metering pump to control a flowrate of acrolein

11. The acrolein leak detection and alert system of claim 1, further comprising a backup power source coupled to the controller, the first and second pressure sensors, the alert system, and the communication interface.

12. A method for acrolein leak detection and alerting, comprising:
pumping, via a metering pump, acrolein from an acrolein source to an injection point of a flowline at the well location;
detecting a first pressure in a suction line disposed between the acrolein source and the metering pump;
detecting a second pressure in a discharge line disposed between the metering pump and the injection point;
receiving, via a controller, pressure measurements from the first and second pressure sensors;
determining, via the controller, whether a potential leak is present between the acrolein source and the acrolein injection point based on the pressure measurements; and
upon determining a potential leak is present,
outputting a control signal from the controller to the metering pump to halt operation of the metering pump,
outputting a control signal from the controller to an alert system to initiate a local warning sequence, and
communicating an alert via a communication interface coupled to the controller to one or more remote personnel devices.

13. The method of claim 12, further comprising transmitting the pressure measurements to the controller, wherein the controller is located remote from the well location.

14. The method of claim 12, wherein determining the potential leak is present comprises determining whether a differential pressure between the pressure measurements from the first and second pressure sensors is outside a predetermined threshold.

15. The method of claim 12, further comprising initiating the local warning sequence, wherein the local warning sequence comprises operating one or more light sources located at the well location.

16. The method of claim 12, further comprising:
detecting a measurement at the well location via an atmospheric or aldehyde sensor; and
determining whether the potential leak is present between the acrolein source and the acrolein injection point based on the pressure measurements and the measurement from the atmospheric or aldehyde sensor.

17. The method of claim 12, further comprising controlling a flowrate of the metering pump pumping the acrolein to the injection point via the controller.

18. The method of claim 12, further comprising:
injecting the acrolein into a fluid in the flowline to generate a treated fluid; and
performing surface water treatment at the well location via the treated fluid.

19. The method of claim 12, further comprising:
providing power to at least one of the controller, the first and second pressure sensors, the alert system, and the communication interface via a backup power source; and
communicating to the one or more remote personnel devices that an acrolein leak detection and alert system is operating on backup power upon providing the power.

20. The method of claim further comprising continuously injecting the acrolein into the flowline.
